(19) United States
(12) Patent Application Publication
(10) Pub. No.: US 2023/0011592 A1
(43) Pub. Date: Jan. 12, 2023

(54) INFLATABLE BLADDER FOR HEADGEAR WITH CLIMATE CONTROL

(71) Applicant: RPB Safety, LLC, Royal Oak, MI (US)

(72) Inventors: Garth Ivory, Bloomfield Hills, MI (US); Julia Bartnick-Thumm, Felanitx (ES)

(21) Appl. No.: 17/857,171

(22) Filed: Jul. 5, 2022

Related U.S. Application Data
(60) Provisional application No. 63/218,539, filed on Jul. 6, 2021.

(51) Int. Cl. A42B 3/28; A42B 3/12

(52) U.S. Cl. CPC A42B 3/283; A42B 3/122

(57) ABSTRACT

An inflatable bladder and comfort control device is provided for mounting within headgear. The inflatable bladder and comfort control device have at least one inflatable bladder adapted to be positioned against a user's head. An air supply source is operatively connected to the inflatable bladder to inflate the bladder and provide air to the user. A directional valve is operatively mounted within the air supply source to separate the air supply source into flow paths to inflate the at least one inflatable bladder, and to create air flow adjacent the user. A directional valve controls the air flow to the bladder and the user's face. Comfort openings are in fluid communication with the air flow path to supply air to adjacent a user's head.

### RELATED APPLICATIONS

This application claims the benefit of U.S. Provisional Application No. 63/218,539 filed on Jul. 6, 2021.

### STATEMENT REGARDING FEDERALLY SPONSORED RESEARCH

NONE.

### TECHNICAL FIELD

This invention relates generally to headgear and more particularly to headgear that can be inflated for better fit and comfort and to provide climate control to the user. The present invention is particularly beneficial with respiratory protective gear.

### BACKGROUND OF THE INVENTION

Headgear such as helmets, a hood with a face shield, a face shield, etc. have common problems of fit and climate control. This is particularly a problem with headgear used in industrial settings where the user is wearing the headgear for extended periods of time and often in extreme conditions of high heat or cold.

Personal protective equipment, especially respiratory protective gear is of immense importance for work environments in numerous industries. Among those industries (but not limited to these) are abrasive blasting, welding/fabrication, painting, foundries, chemical pharmaceutical, and laboratories.

In many cases, workers need to wear their respirators throughout the entire workday, which make comfort, climate control and noise cancellation crucial factors not only for the workers' health and well-being but also for their productivity and workplace safety. To ensure regular proper use, the respirators need to be comfortable and pleasant to wear.

A critical factor for user comfort is proper fit. This is particularly true with headgear, such as helmets. Different padding sizes are available, but there isn't a perfect fit for every head shape. Furthermore, users are not guaranteed that they will be equipped with the best matching size and conditions may vary over time because of haircuts, glasses, hearing aids, etc.

A good and therefore relatively tight-fitting helmet can be inconvenient to put on. For instance, glasses, jewelry, and hair can get in the way by pressing against the face or slipping out of position. The downward movement of the tight padding can cause facial skin, particularly around the cheeks to be irritated, or can fold the user's ears which is uncomfortable.

There is also the need to provide climate control for added comfort. Many times, headgear is used in adverse climates with extreme heat or cold. The user's discomfort is increased when working in these extreme environments wearing protective gear. The adverse conditions can create discomfort regardless of the type of headgear used, whether it is a helmet, a hood with a face shield, a face shield, etc.

The problem of headgear fit, and comfort control is found in all types of headgear and is not limited to personal protective equipment used in work environments. Helmets used for example in sports, such as car and motorcycle racing etc. suffer the same issues.

The present invention solves these disadvantages by providing individually adaptable helmet bladders that are inflated after putting on the helmet. In addition, the headgear allows air to pass through or around the bladders to the user. The air can be either hot or cold to provide climate control to the user.

### SUMMARY OF THE INVENTION

In general terms, this invention provides an inflatable bladder and comfort control device for mounting within headgear. The inflatable bladder and comfort control device has at least one inflatable bladder adapted to be positioned against a user's head. An air supply source is operatively connected to the at least one inflatable bladder for inflation and comfort control.

In one embodiment a directional valve is operatively mounted within the air supply source to separate the air supply source into a first flow path and a second flow path. The first flow path can supply comfort air and/or supply air to an inflatable bladder to inflate the inflatable bladder; the second flow path supplies air to create air flow adjacent a user's face and head to be breathed and/or to provide comfort air.

The directional valve is normally open to open the second flow path to supply air to create air flow adjacent a user's face and head. The directional valve is selectively operated to open the first flow path to inflate the at least one inflatable bladder or to supply comfort air. When used to inflate the inflatable bladder, the valve can be closed once inflated as desired, the directional valve closes the first flow path to maintain inflation of the inflatable bladder. When used to supply comfort air, the directional valve can be left open or partially closed to control the comfort air flow.

Comfort openings can be in fluid communication with the second flow path to supply air from the second flow path to adjacent a user's face. In this way, the first flow path supplies air to inflate the at least one inflatable bladder to mount to a user's head and the second flow path supplies air to create airflow adjacent a user's face for breathing and to supply air through the comfort openings to a user's head for comfort.

The inflatable bladder and comfort control device can be used on a variety of headgear, but is especially suited for use with headgear used in industrial settings where the user is wearing the headgear for extended periods of time and often in extreme conditions of high heat or cold.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a side view of headgear with the inflatable bladder and comfort control of the present invention.

FIG. 2 is a perspective view of the inflatable bladder and comfort control of the present invention.

FIG. 3 is a perspective view of the inflatable bladder and comfort control of the present invention.

FIG. 4 is a perspective view of the inflatable bladder and comfort control of the present invention.

FIG. 5 is a side view of protective equipment with the inflatable bladder and comfort control of the present invention.

FIG. 6 is a schematic view of the inflatable bladder and comfort control of the present invention.

FIG. 7 is a schematic view of the inflatable bladder and comfort control of the present invention.

FIG. 8 is a schematic view of the inflatable bladder and comfort control of the present invention.

FIG. 9 is a side view of headgear with the inflatable bladder and comfort control of the present invention.

FIG. 10 is a view of the inflatable bladder and comfort control of the present invention lying flat.

### DETAILED DESCRIPTION OF A PREFERRED EMBODIMENT

The present invention relates to inflatable custom-fit cushioning that is designed to provide a proper fit, manage body temperature, and provide additional impact protection for headgear, such as respirator head pieces and helmets. The cushioning can be an inflatable bladder or can be an inflatable bladder and padding in combination.

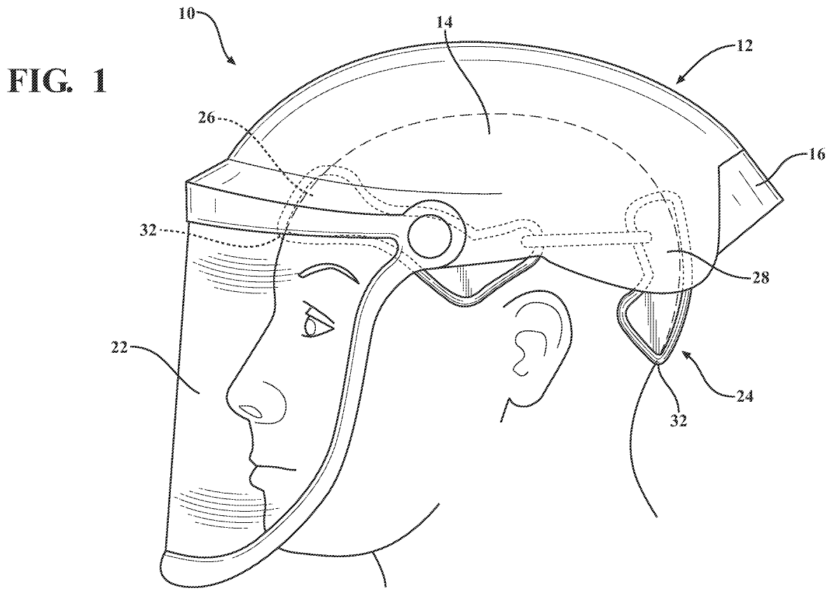

The inflatable headgear with climate control is shown generally at 10 in FIG. 1. In the disclosed embodiment, the headgear 12 is illustrated as a helmet. The invention will be described in connection with headgear for use with respirators that use positive pressure air for breathing; however, it will be understood that it can be used with other types of headgear.

The illustrated headgear 12 has a shell 14 configured to mount to the user's head. The shell 14 has an air inlet 16 into which filtered air is provided by either a powered respirator 18 normally worn by the user, or from an air supply located within the facility, commonly referred to as supplied air. The air supplied is for breathing by the user. An example of a user worn powered air purifying respirator is described in WO2021077056A1 assigned to the assignee of the present application and incorporated herein by reference.

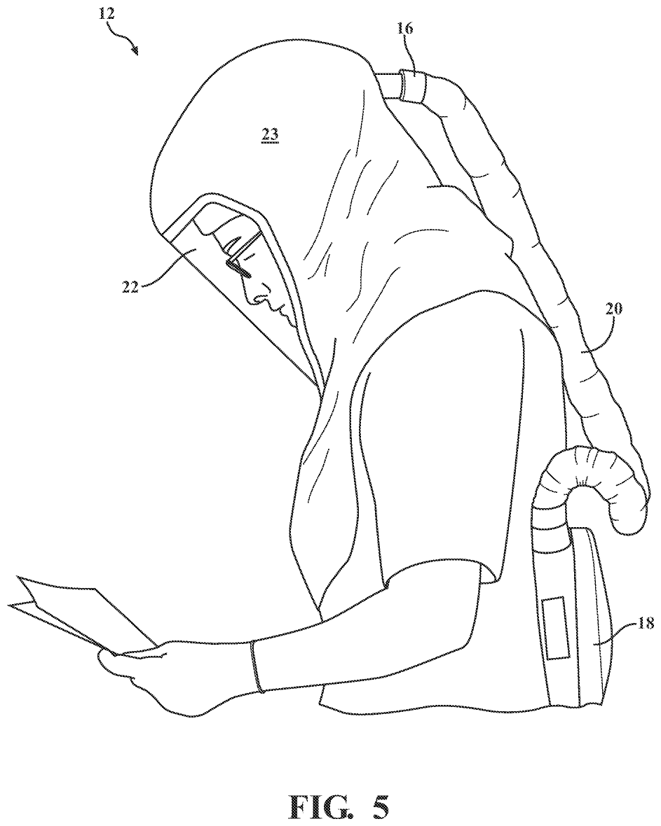

With reference to FIG. 5, a hose 20 connects the air supply to the air inlet 16. The headgear 12 of FIG. 1 includes a face shield 22. The face shield 22 and shell 14 can be directly connected to a garment to provide more protection to the user, or a hood 23 with a face shield 22 as shown in FIG. 5 can cover the headgear 14. As is well known by those of ordinary skill in the art these are examples, and it will be understood that many more alternatives are available.

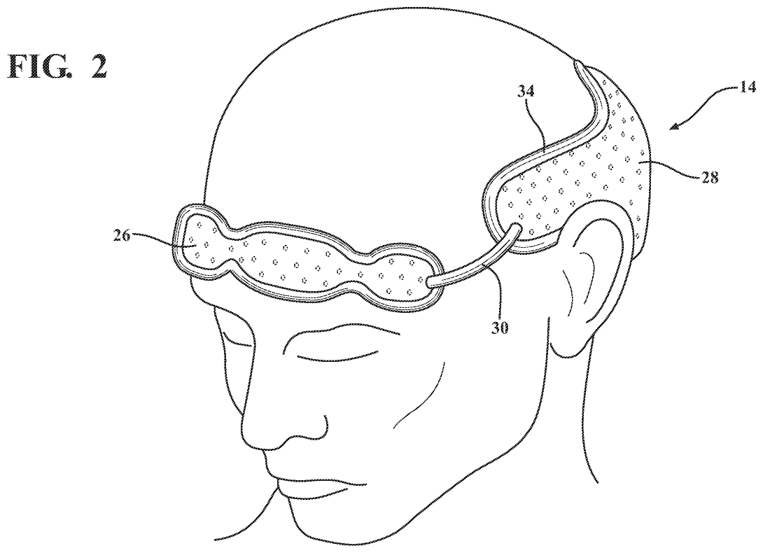

At least one bladder 24 is mounted within the shell 14. It will be understood that bladder 24 can include a single bladder 24, or multiple bladders 24. FIGS. 2, 3 and 4 show alternative bladders 14. As will be understood by those of ordinary skill in the art, in addition to one or two bladders, three or more could be used.

It should also be understood that the present invention includes the use of the comfort control without the bladder. The user would have the ability to receive breathing air and comfort control air in a typical helmet, without the need for the bladder, or an inflatable bladder for comfort fitting.

In FIGS. 1 and 2, the bladder 14 has a frontal or forehead bladder 26 and an occipital bladder 28. The bladders 26 and 28 can be a unitary bladder operatively connected for fluid communication between the bladders, or they can be separate bladders joined by an air tube 30, or they can be separate bladders each fed by one or more air tubes 30. If the bladders 26 and 28 are separate and supplied by separate tubes 30, each bladder can be individually filled as desired for different cushioning and fit.

In this embodiment, the bladders 26 and 28 have either bleed holes 32, see FIG. 1, or a porous material 34 attached to or adjacent the bladders 26 and 28 to allow air to flow through, see FIG. 2. This low flow stream can cool down or warm up the user without causing an unpleasant air draft. The air in the bladder 24 or material is constantly exchanged and replaced by fresh climate-controlled air. The bladder 24 can have a cooling or warming effect to the user. Thermal conductive bladder material, foam or fabric can be used to enhance the effect.

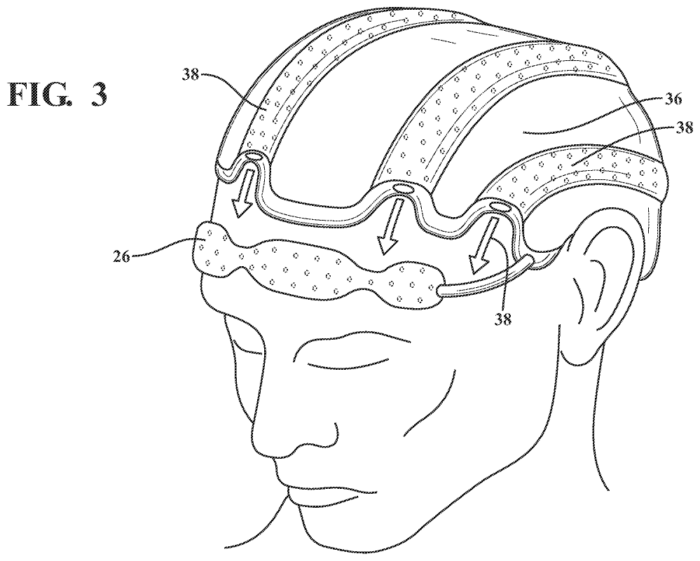

FIG. 3 illustrates a larger head covering bladder 36 and a forehead bladder 26. In this embodiment, the bladder 36 has channels 38 to allow air to flow across the user's head. The channels 38 can also be provided in the forehead bladder 26 or the forehead bladder 26 could have bleed holes 32 or a porous material 34. Instead of the channels 38 being formed in the bladder 36, the channels 38 could be formed by space between adjacent bladders 24. The shape of the air bladders 24 with channels 38 will generally help prevent users from having too much contact surface with the bladders 24 for better comfort.

In the embodiment of FIG. 3, frontal air bladder 26 prevents the headgear 12 from moving closer to the user's face, potentially even touching the nose when the head bladder 36 is inflated. The larger head bladder 36 can have varying diameters in its inflated state.

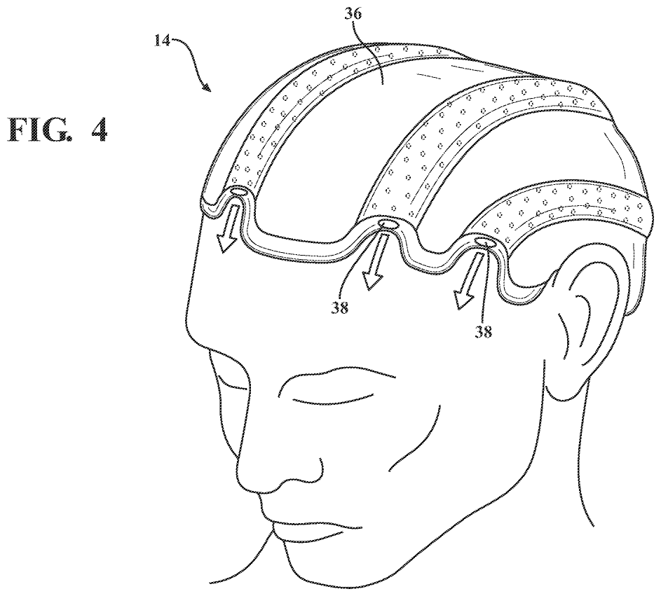

FIG. 4 illustrates a larger head covering bladder 36 without the forehead bladder 26. In this embodiment, channels 38 allow air to flow across the user's head. As should be appreciated bleed holes 32 or a porous material 34 could also be used.

When used with a powered air purifying respirator 18 (PAPR), see FIG. 5, the headgear can use the supplied air system of the respirator 18 for the initial inflation of the bladders 24 and the constant air flow for the climate-controlled air and breathing air for the user. The PAPR 18 supplies air to the headgear 12. Hose 20 connects to the headgear 12 and supplies constant air flow at a pre-determined rate for breathing and supplies comfort control air.

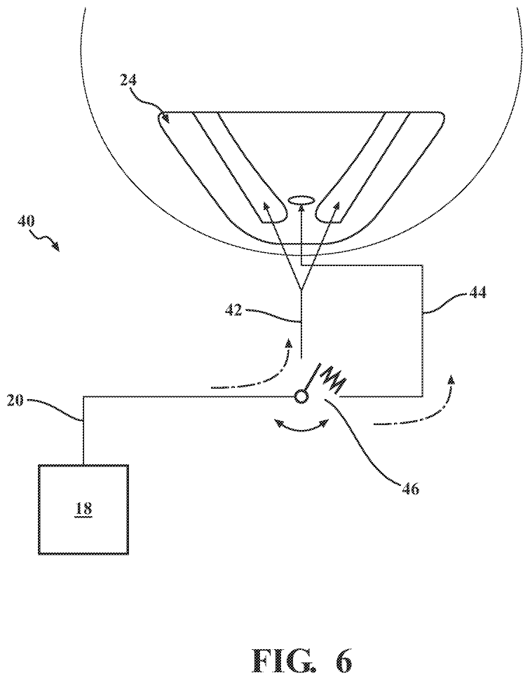

FIG. 6 illustrates an example schematic of a system 40 of the present invention with a PAPR 18. A first air line 42 can connect to the inlet 16 and bladder 24 to supply comfort air to the bladder 24 for flow through the bleed holes or mesh or the comfort air can flow through the channels 38. This air would flow adjacent the user's head and face. This air can be the breathing air or the breathing air can be supplied through a different flow path. A second air line 44 supplies inflation air to the bladder 24. A valve 46 controls the air flow to the second air line 44. Valve 46 is normally closed to block air flow to bladder 24 and is opened by the user to fill the bladder 24. This allows the user to fill the bladder 24 to the desired level for comfort and fit and then maintain that fill. It also allows the air to constantly flow through the first air line 42 to provide filtered air and comfort air to the user. Valve 46 can be for example a manual valve controlled by a lever or push button or a solenoid valve controlled by the user or by the PAPR control unit or a combination of these. The valve control can be mounted on the headgear 14.

FIG. 6 also illustrates an alternative embodiment that uses the first air line 42 to provide breathing air to the user and the line 44 to provide comfort air. In this embodiment, there is normal padding 24 to direct comfort air. In this embodiment, the comfort air flows through the line 44 and is controlled by the valve 46.

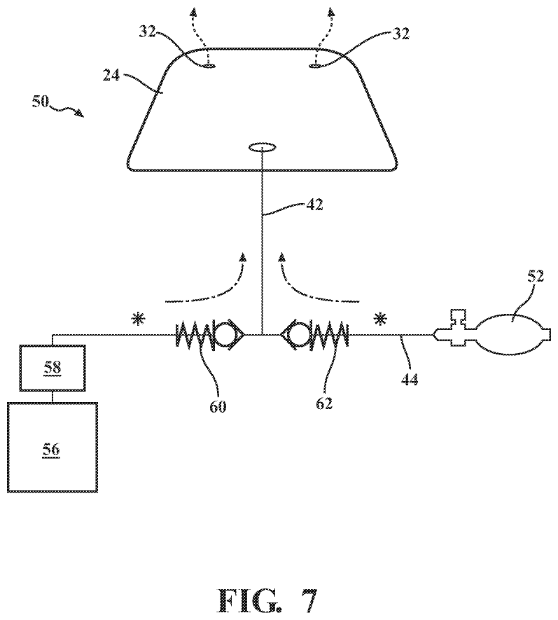

FIG. 7 illustrates another example schematic of a system 50 that includes a bladder 24 that is inflated by a pump 52, shown as a handpump, for adjusting the fit and an air supply 56. In this embodiment the air supply 56 can be provided by connection to air supplied by the facility, commonly referred to in the industry as supplied air. In this embodiment the climate control includes a temperature management device 58. An example of a temperature management device 58 is disclosed in applicant's U.S. Pat. Nos. 10,537,756 and 9,599,372 both assigned to the assignee of the present application and incorporated herein by reference. System 50 includes check valves 60 and 62. Valve 60 is normally open to supply filtered air and comfort air to the user and valve 62 is normally closed. When the pump 52 is used, valve 62 is opened and valve 60 is closed by the pump 52 pressure. This allows the bladder 24 to be filled to a desired inflation and then closed by valve 62 to hold that inflation with the valve 60 remaining open for constant air supply to the user.

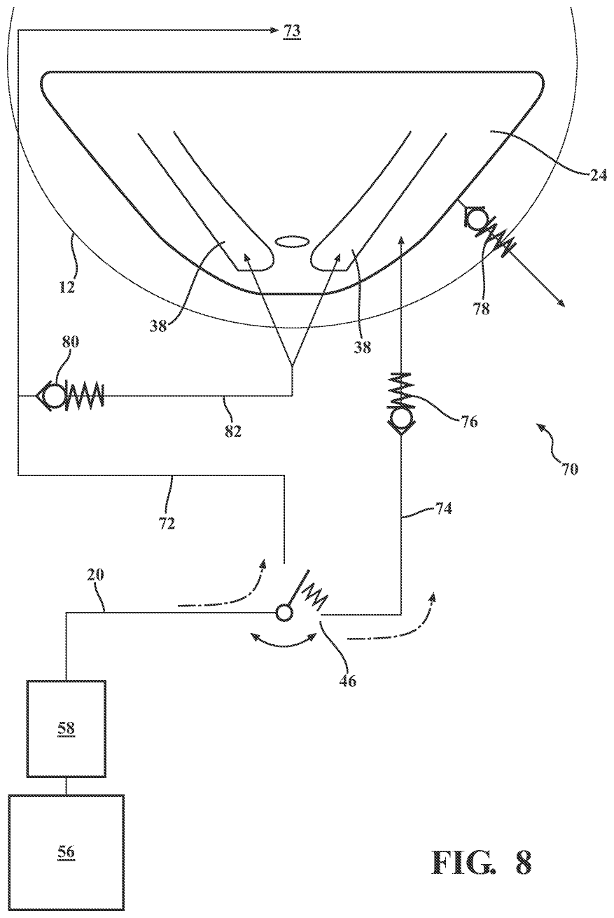

FIG. 8 illustrates another example schematic of a system 70 which includes a bladder 24 that that includes channels 38 for flow of the comfort air. In this embodiment the air supply is illustrated by supplied air 56 but could be by PAPR. In this embodiment the climate control includes the temperature management device 58. System 70 includes an air hose 20 which connects to inlet 16. A valve 46 then connects hose 20 to air line 72 that supplies filtered air to the user in the breathing zone or the area adjacent the user's face 73 and a line 74 that inflates the bladder 24. The valve 46 normally provides air to the line 72. When the valve is moved to the inflate position, the hose 20 is connected to line 74 to provide air flow to inflate the bladder 24. A check valve 76 is in the line 74 to allow air to flow only in one direction so that when the bladder is inflated to the desired amount, it will maintain its inflation. A one way release valve 78 is provided to allow the bladder 24 to be deflated as desired for comfort, fit, or to be emptied. Valve 78 is operated by the user and could be manual or controlled through the PAPR system or an onboard CPU.

A second pressure sensitive valve 80 is located between lines 72 and 82. Valve 80 opens to allow comfort air to be supplied to bladder 24 and in particular to channels 38 as illustrated. It will be understood by those of ordinary skill in the art that bleed holes or a material or a combination of these could be used. The valve 80 opens when there is a predetermined amount of pressure in the line 72. In this way, there is only comfort air when there is sufficient filtered air supplied to the user in area 73.

The overall weight of respirator headgear 12, particularly helmets is an important factor for the user's comfort. A decrease of the weight carried on the user's head reduces stress on neck, shoulder, and back muscles as well as pressure points on the head. Inflatable bladders 24 help to reduce the weight of the headgear 12, since less material is needed compared to the same amount of padding filled with dense materials such as foam or textiles used in traditional headgear.

Besides the intrinsic weight of the headgear 12, the weight or pressure distribution plays a significant role in comfort. In accordance with the physical principle of following the path of least resistance, the air inside the bladders 12 always distributes itself equally in the space between the user's head and for example the headgear's 12 hard shell 14. In this way, the headgear 12 conveys a lighter feel and prevents single pressure points on the head. An optimal adaption to every wearer's head shape can be achieved that otherwise is not available.

Another advantage regarding production optimization is that with an adaptable air bladder 24, the number of various parts and product versions can be reduced. This saves cost and simplifies assembly and storage processes.

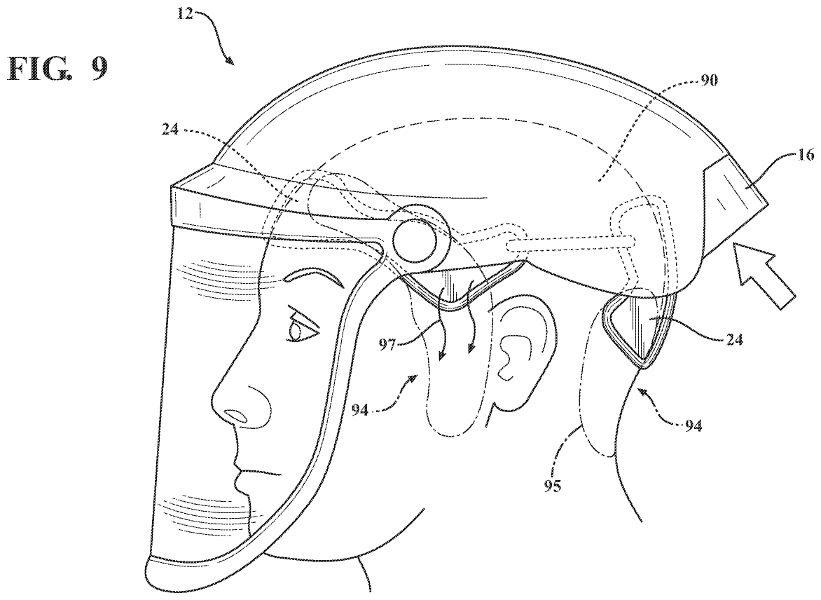

In the embodiment illustrated in FIG. 9, for optimal user comfort, the inflatable compartments of the bladders 24 are framed by padding 90, such as foam, soft plastic or thermoformed lining 90. Padding 90 facilitates the placement and inflation of the air bladders 24 as intended. Padding 90 can also protect the bladders 24 from damage and early wear. The shape of the inflatable compartments can be influenced by varying stiffness and thickness of the material as well as baffles or thermoforming.

Bladder 24 can be removably connected for example, by Velcro or by attachments molded into the headgear 12 or polystyrene padding inserted into the headgear 12. The user-facing surfaces of the bladder 24 can be covered by textile. Ideally, this textile cover would be antibacterial, washable durable and have a pleasant feel on skin.

With reference to FIG. 9, the inflatable bladder 24 is designed to help direct the comfort air to consciously chosen temperature target areas 94. Such areas are (but are not limited to) the lower occipital and neck region proximal to the external carotid arteries and brain stem shown generally at 95 as well as the forehead and temporal region in front of the ears proximal to the superficial temporal arteries shown generally at 97. The large superficial blood vessels in these areas can spread the cooling or heating sensation through the user. The aim of specifically targeting the described areas is to increase the user's sensation of being cooled or warmed and therefore comfort in high as well as low temperature environments compared to the effect the same amount of climate-controlled air would have if just randomly distributed in the helmet.

Through a cushioning effect and by providing a snug fit around the ears, the inflatable liner also increases the level of noise cancellation. The cushioning can also enhance the head piece's impact absorption.

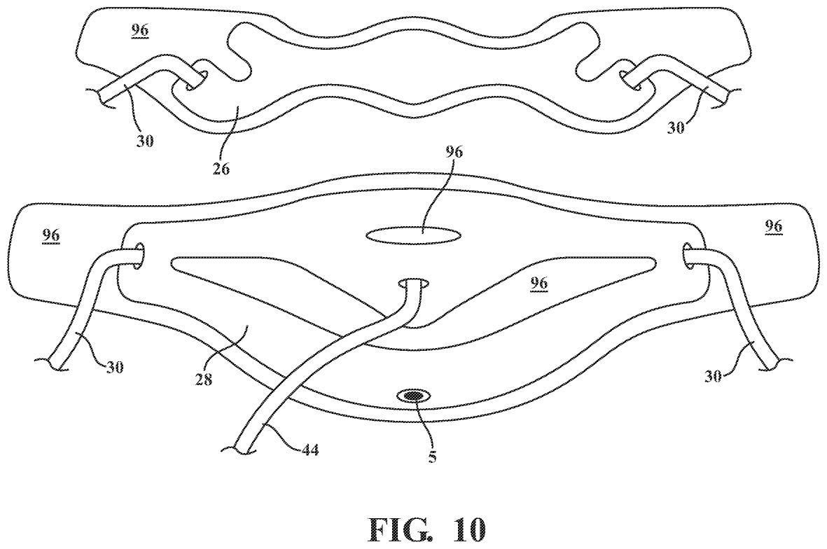

FIG. 10 is a view of the bladders 26 and 28 lying flat. The bladders are inflated by air flow through the air inlet tube 44 in the occipital bladder 28. The inlet tube 44 has one-way valve 74 to prevent air from streaming out of the bladder 28. The inflatable bladders 24 can be shaped in many possible ways. They are designed to ergonomically frame the wearer's head and avoid too much contact between the user's head and the inner lining of the headgear 12. The outer areas of the compartments 96 are used for sutures, Velcro, or other attachment methods to attach to the headgear 12 and the rest of the lining in the headgear 12. As indicated above, the frontal or forehead bladder 26 and rear or occipital bladder 28 can be part of the same bladder or be interconnected with air lines or tubes 30.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A respirator headgear comprising:
an outer shell configured to be positioned upon a user's head;
at least one inflatable bladder mounted within said outer shell, said at least one inflatable bladder adapted to be positioned against a user's head;
an air supply source operatively connected to said respirator headgear, said air supply source having a first flow path and a second flow path, said first flow path supplying air to said inflatable bladder to inflate said bladder; said second flow path supplying air within said respirator headgear to create positive pressure within said headgear;
comfort openings within said respirator headgear to supply air from said second flow path to a user's head;
whereby said first flow path supplies air to inflate said at least one inflatable bladder to comfortably mount to a user's head and said second flow path supplies air within said respirator headgear to create positive air pressure within said respirator headgear and to supply air through said comfort openings to a user's head for comfort.

2. The respirator headgear of claim 1, further including a filter to filter the air before the air enters said first and second flow paths.

3. The respirator headgear of claim 1, wherein said headgear is a helmet.

4. The respirator headgear of claim 1, further including more than one at least one bladder, said comfort openings are channels formed between said more than one at least one bladders.

5. The respirator headgear of claim 1, wherein said comfort openings are channels formed within said bladder.

6. The respirator headgear of claim 1, wherein said at least one inflatable bladder includes a secondary material with openings, said first flow path supplying air to said material to flow through said openings.

7. The respirator headgear of claim 1, further including padding mounted within said outer respirator headgear, said at least one bladder is mounted adjacent said padding.

8. The respirator headgear of claim 1, wherein said at least one bladder includes an occipital bladder and a forehead bladder.

9. The respirator headgear of claim 8, wherein said occipital bladder and said forehead bladder are interconnected by air tubes.

10. The respirator headgear of claim 1, further including an exhaust valve operatively connected to said at least one bladder to selectively exhaust air from said bladder.

11. The respirator headgear of claim 1, further including a first one-way pressure valve operatively connected between said first flow path and said second flow path, said first one-way valve normally closing the first flow path from the second flow path and opening the first flow path to the second flow path when a predetermined pressure is reached;
whereby said second flow path can supply air to said at least one bladder when said predetermined pressure is reached to supply a continuous flow of air to said comfort openings.

12. The respirator headgear of claim 11, further including a second one-way pressure valve in said first flow path to allow air to inflate said at least one bladder and prevent air from escaping said at least one bladder.

13. The respirator headgear of claim 1, including a one way pressure exhaust valve connected to said bladder to exhaust pressure from said bladder that reaches predetermined pressure to prevent damage to said bladder.

14. The respirator headgear of claim 1, wherein said bladder includes bleed holes to provide comfort air to the user.

15. The respirator headgear of claim 1, wherein said air supply source is a powered air purifying respirator.

16. The respirator headgear of claim 1, wherein said air supply source is supplied air.

17. The respirator headgear of claim 1, further including a directional valve operatively mounted within said air supply source to separate said air supply source into said first flow path and said second flow path.

18. The respirator headgear of claim 1, further including a pump to inflate said at least one inflatable bladder.

19. A respirator helmet comprising:
an outer shell configured to be positioned upon a user's head;
at least one inflatable bladder mounted within said outer shell, said at least one bladder adapted to be positioned against a user's head;
an air supply source operatively connected to said respirator helmet;
a directional valve operatively mounted within said air supply source to separate said air supply source into a first flow path and a second flow path, said first flow path supplying air to said at least one bladder to inflate said bladder; said second flow path supplying air within said respirator helmet to create positive pressure within said helmet;
said directional valve being normally open to open said second flow path to supply air within said respirator helmet to create positive pressure within said helmet, said directional valve being selectively operated to open said first flow path to inflate said at least one bladder, once inflated as desired, said directional valve closes said first flow path to maintain inflation of said at least one bladder;
comfort openings within said respirator helmet, said comfort openings being in fluid communication with said second flow path to supply air from said second flow path to a user's head;
whereby said first flow path supplies air to inflate said air at least one bladder to mount to a user's head and said second flow path supplies air within said respirator helmet to create positive air pressure within said respirator helmet and to supply air through said comfort openings to a user's head for comfort.

20. The respirator helmet of claim 19, further including a filter to filter the air before the air enters at least said second flow path.

21. The respirator helmet of claim 19, further including more than one at least one bladder, said comfort openings are channels formed between said more than one at least one bladders.

22. The respirator headgear of claim 19, wherein said comfort openings are channels formed within said bladder.

23. The respirator helmet of claim 19, wherein said at least one inflatable bladder includes a secondary material with openings, said first flow path supplying air to said material to flow through said openings.

24. The respirator helmet of claim 19, further including padding mounted within said helmet, said at least one bladder is mounted adjacent said padding.

25. The respirator helmet of claim 19, wherein said at least one bladder includes an occipital bladder and a forehead bladder.

26. The respirator headgear of claim 25, wherein said occipital bladder and said forehead bladder are interconnected by air tubes.

27. The respirator helmet of claim 19, further including an exhaust valve operatively connected to said at least one bladder to selectively exhaust air from said bladder.

28. The respirator helmet of claim 19, further including a first one-way pressure valve operatively connected between said first flow path and said second flow path, said first one-way valve normally closing the first flow path from the second flow path and opening the first flow path to the second flow path when a predetermined pressure is reached;
whereby said second flow path can supply air to said at least one bladder when said predetermined pressure is reached to supply a continuous flow of air to said comfort openings.

29. The respirator helmet of claim 28, further including a second one-way pressure valve in said first flow path to allow air to inflate said at least one bladder and prevent air from escaping said at least one bladder.

30. The respirator helmet of claim 19, further including a one way pressure exhaust valve connected to said bladder to exhaust pressure from said bladder that reaches a predetermined pressure to prevent damage to said bladder.

31. The respirator helmet of claim 19, wherein said bladder includes bleed holes to provide comfort air to the user.

32. The respirator helmet of claim 19, wherein said air supply source is a powered air purifying respirator.

33. The respirator helmet of claim 19, wherein said air supply source is supplied air.

34. The respirator helmet of claim 19, further including a pump to inflate said at least one inflatable bladder, said directional valve is a check valve to open said first flow path to allow said pump to inflate said at least one inflatable bladder.

35. An inflatable bladder and comfort control device for mounting within headgear, comprising:
at least one inflatable bladder adapted to be positioned against a user's head;
an air supply source operatively connected to said at least one inflatable bladder;
a directional valve operatively mounted within said air supply source to separate said air supply source into a first flow path and a second flow path, said first flow path supplying air to said at least one inflatable bladder to inflate said at least one inflatable bladder; said second flow path supplying air to create air flow adjacent a user's face;
said directional valve being normally open to open said second flow path to supply air to create air flow adjacent a user's head, said directional valve being selectively operated to open said first flow path to inflate said at least one inflatable bladder, once inflated as desired, said directional valve closes said first flow path to maintain inflation of said inflatable bladder;
comfort openings in fluid communication with said second flow path to supply air from said second flow path to adjacent a user's face;
whereby said first flow path supplies air to inflate said at least one inflatable bladder to mount to a user's head and said second flow path supplies air to create airflow adjacent a user's face and to supply air through said comfort openings to a user's head for comfort.

36. The inflatable bladder and comfort control device of claim 35, further including a filter to filter the air before the air enters at least said second flow path.

37. The inflatable bladder and comfort control device of claim 35, further including more than one inflatable bladders, said comfort openings are channels formed between said more than one inflatable bladders.

38. The inflatable bladder and comfort control device of claim 35, wherein said comfort openings are channels formed within said at least one inflatable bladder.

39. The inflatable bladder and comfort control device of claim 35, wherein said at least one inflatable bladder includes a secondary material with openings, said first flow path supplying air to said material to flow through said openings.

40. The inflatable bladder and comfort control device of claim 35, wherein said headgear is a shell adapted to mount to a user's head;
padding mounted within said shell;
said inflatable bladder is mounted adjacent said padding.

41. The inflatable bladder and comfort control device of claim 35, wherein said at least one inflatable bladder includes an occipital bladder and a forehead bladder.

42. The inflatable bladder and comfort control device of claim 41, wherein said occipital bladder and said forehead bladder are interconnected by air tubes.

43. The inflatable bladder and comfort control device of claim 35, further including an exhaust valve operatively connected to said at least one inflatable bladder to selectively exhaust air from said bladder.

44. The inflatable bladder and comfort control device of claim 35, further including a first one-way pressure valve operatively connected between said first flow path and said second flow path, said first one-way valve normally closing the first flow path from the second flow path and opening the first flow path to the second flow path when a predetermined pressure is reached;
whereby said second flow path can supply air to said at least one inflatable bladder when said predetermined pressure is reached.

45. The inflatable bladder and comfort control device of claim 44, further including a second one-way pressure valve in said first flow path to allow air to inflate said inflatable bladder and prevent air from escaping said inflatable bladder.

46. The inflatable bladder and comfort control device of claim 35, further including a one-way pressure exhaust valve connected to said at least one bladder to exhaust pressure from said at least one bladder that reaches a predetermined pressure to prevent damage to said at least one bladder.

47. The inflatable bladder and comfort control device of claim 35, wherein said at least one bladder includes bleed holes to provide comfort air to the user.

48. The inflatable bladder and comfort control device of claim 19, further including a pump to inflate said at least one inflatable bladder, said directional valve is a check valve to open said first flow path to allow said pump to inflate said at least one inflatable bladder.

49. A respirator headgear comprising:
an outer shell configured to be positioned upon a user's head;
an air supply source operatively connected to said respirator headgear, said air supply source having a first flow path and a second flow path, said first flow path supplying comfort air, said second flow path supplying breathing air within said respirator headgear;
comfort openings within said respirator headgear to supply air from said first flow path to a user's head;
whereby said first flow path supplies air within said respirator headgear to supply air through said comfort openings to a user's head for comfort, said second flow path suppling air to the breathing area of the headgear as breathing air.

50. The respirator headgear of claim 49, further including a directional valve operatively mounted within said air supply source to separate said air supply source into said first flow path and said second flow path.
